(19) United States
(12) Patent Application Publication
(10) Pub. No.: US 2014/0310263 A1
(43) Pub. Date: Oct. 16, 2014

(54) Method and Apparatus of Recommending an Internet Transaction

(71) Applicant: Alibaba Group Holding Limited, Grand Cayman (KY)

(72) Inventors: Fudi Liu, Hangzhou (CN); Guocheng Chen, Hangzhou (CN); Meng Jiang, Hangzhou (CN); Qiang Li, Hangzhou (CN)

(73) Assignee: Alibaba Group Holding Limited, Grand Cayman (KY)

(21) Appl. No.: 14/251,458

(22) Filed: Apr. 11, 2014

(30) Foreign Application Priority Data
Apr. 16, 2013 (CN) 201310130935.7

(51) Int. Cl. G06F 17/30

(52) U.S. Cl. CPC G06F 17/30867; G06F 17/30321; G06F 17/30598
USPC 707/722

(57) ABSTRACT

A method and an apparatus of recommending an Internet transaction are provided herein. A feedback result of an Internet transaction request may be optimized using a technical scheme of the present disclosure. Specifically, after receiving an Internet transaction request from a client of a user, response web server determines a feedback result of the Internet transaction request on the one hand, and queries information of a user group of the user on the other hand. Based on respective Internet transaction activities corresponding to information of at least two users in the information of the user group, the web server performs optimization for the feedback result of the Internet transaction request. Using this technical scheme, the occupancy of network resources due to blind selection of information objects by users may be reduced, thus improving the service efficiency of the web server.

### CROSS REFERENCE TO RELATED PATENT APPLICATION

This application claims foreign priority to Chinese Patent Application No. 201310130935.7 filed on Apr. 16, 2013, entitled “Method and Apparatus of Recommending Internet Transaction”, which is hereby incorporated by reference in its entirety.

### TECHNICAL FIELD

The present application relates to the field of Internet technology, and particularly, to methods and apparatuses of recommending Internet transaction.

### BACKGROUND

Due to the arrival of the electronic information age, the Internet has played an ever increasingly vital role in the lives of people. People may obtain various types of information through the Internet swiftly in real time. The use of the Internet offers great convenience to the lives and work of people, thus currently becoming a technology with widespread application.

Due to the popularity of the Internet, the Internet has become a basic method of conducting business. A transaction that is achieved using the Internet is generally called an Internet transaction. Currently, Internet transactions are very diverse in types, and related transactions are mainly implemented through each server that is deployed in a network. For example, web servers in widely used transaction-type websites mainly provide various types of transaction services to a great number of users. A provider of information objects presents available descriptive information of the information objects on a web page for users to select. In particular, the descriptive information that is presented may include a photo, a name, a usage, and a price of an information object, etc. Accordingly, a user may browse the information objects on the web page to select an object he/she desires for subsequent transaction.

With the existence of many factors, selecting a transaction object merely based on descriptive information of an information object has a low reliability. Currently, a commonly used selection method is to review evaluation information associated with an information object. FIG. 1 is a flowchart showing a process of selecting an information object by a user through reviewing evaluation information, which may include the following blocks 101 to 104:

At block 101, a user selects and clicks to enter a web page associated with an information object.

In this block, the information object selected and clicked by the user is an information object displayed on an Internet page. Such Internet page may be a home page provided by a web server, or a search result page returned by the web server based on a search request of the user.

At block 102, the user enters into an evaluation list of the information object, and reviews individual pieces of evaluation information of other users given to the information object.

In this block, the user enters into the evaluation list of the information object via an interface of the evaluation list provided by the web page that displays the information object.

At block 103, the user determines whether the information object satisfies his/her need based on the evaluation information of the other users. If affirmative, block 104 is performed. If not, block 101 is performed.

At block 104, the user selects the information object.

In this block, the user may select the information object in many different ways, e.g., by making a purchase directly, adding into a shopping cart or bookmarking the information object.

The process of selecting an information object by a user through reviewing evaluation information is finished at this point.

In the process corresponding to FIG. 1, a user selects an information object presented on a web page, and performs selection normally according to a display order of information objects, e.g., performing selection in an order starting from a first information object on the web page, until an object satisfying his/her demand is selected. In a real network environment, whether evaluation information of an information object of a user is good or bad is not ascertained, requiring users to review each piece individually for determination. As such, the method of selecting an information object by a user through reviewing evaluation information is a blind selection method. Specifically, in the process of selecting an information object, a user needs to enter into pages that display different information objects multiple times in order to review evaluation information given by a multitude of other users. For the user, the efficiency of selecting an information object is low, thus degrading the experience of the user. For a web server, pages that display the information objects and corresponding evaluation are loaded continually in response to requests from the user, thus occupying a large amount of network resources and lowering the efficiency of the web server.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or computer-readable instructions as permitted by the context above and throughout the present disclosure.

In view of the above, exemplary embodiments of the present disclosure provide a method and an apparatus of recommending Internet transaction. By using this technical scheme, the occupancy of network resources due to a blind selection of information objects by users can be reduced, thus improving the service efficiency of a web server.

The embodiments of the present disclosure are implemented using the following technical schemes.

According to an aspect of the embodiments of the present disclosure, a method of recommending Internet transaction is provided, which includes:

receiving an Internet transaction request sent from a client of a first user; querying user group information of the first user, the user group information including information of at least two users; and

optimizing a feedback result of the Internet transaction request based on Internet transaction activity information corresponding to the information of the at least two users.

According to another aspect of the embodiments of the present disclosure, an apparatus of recommending Internet transaction is further provided, which includes:

a transaction request receiving unit used for receiving an Internet transaction request sent from a client of a first user;

a user group maintenance unit used for querying user group information of the first user, the user group information including information of at least two users; and

a feedback result optimization unit used for optimizing a feedback result of the Internet transaction request based on Internet transaction activity information corresponding to the information of the at least two users.

Using at least one technical scheme provided by the foregoing embodiments of the present disclosure, after receiving an Internet transaction request sent from a client of a first user, a web server determines a feedback result of the Internet transaction request on the one hand, and queries user group information of the user on the other hand. Based on Internet transaction activity information of other users in the user group information, the web server performs optimization for the feedback result of the Internet transaction request. Compared with existing technologies, the technical schemes of the present disclosure can optimize a feedback result based on Internet transaction activities of other users prior to returning the feedback result associated with an Internet transaction. Compared to the blind selection method of entering into an information object to review user evaluation by a user in the existing technologies, a feedback result which is returned to the user has undergone optimization based on Internet activity information of users (e.g., evaluation information of the users for information objects) using the technical schemes of the present disclosure, thus achieving a goal of helping the user to select an information object, improving the efficiency of selecting an information object that meets a demand of the user, reducing the occupancy of network resources and improving the service efficiency of a web server.

Other characteristics and advantages of the present application will be described in this disclosure hereinafter, and will become clear from the disclosure or will be understood through the embodiments of the present disclosure. The goals and other advantages of the present application can be realized and obtained through structure(s) that is/are specifically described in the specification, claims and drawings.

### BRIEF DESCRIPTION OF THE DRAWINGS

The accompanying drawings are used to provide a further understanding of the present application, and form a part of the disclosure. The drawings are used to describe the present application in combination with the embodiments, and are not construed as limitations of the present application. In the drawings:

FIG. 1 is a flowchart illustrating a process of selecting an information object by a user through reviewing evaluation information in prior art technology.

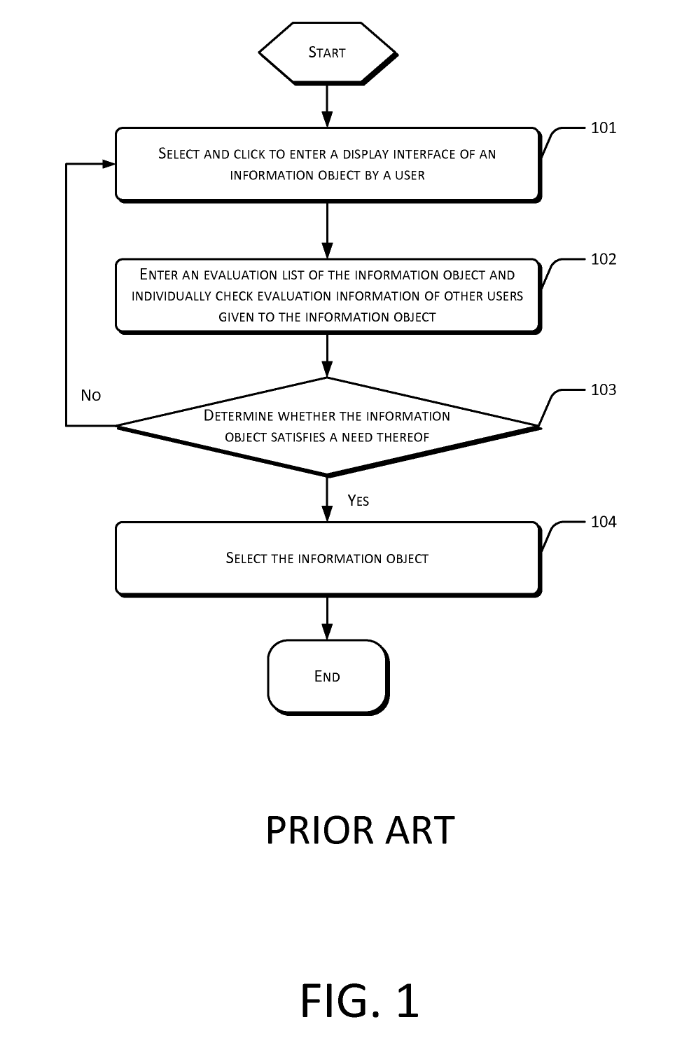

FIG. 2 is a flowchart illustrating a process of recommending Internet transaction in accordance with a first embodiment of the present application.

FIG. 3 is a flowchart illustrating a process of creating a user group of a first user in accordance with the first embodiment of the present application.

FIG. 4 is a schematic diagram of user relationship in accordance with the first embodiment of the present application.

FIG. 5 is a flowchart illustrating an optimization process when an Internet transaction request is a search request for an information object in accordance with the first embodiment of the present application.

FIG. 6 is a schematic diagram of the optimization process in FIG. 5 in a real application.

FIG. 7 is a flowchart illustrating another optimization process when an Internet transaction request is a search request of an information object in accordance with the first embodiment of the present application.

FIG. 8 is a schematic diagram of the optimization process in FIG. 7 in a real application.

FIG. 9 is a flowchart illustrating an optimization process when an Internet transaction request is an access request in accordance with the first embodiment of the present application.

FIG. 10 is a schematic diagram of the optimization process in FIG. 9 in a real application.

FIG. 11 is a structural diagram of an apparatus of recommending Internet transaction in accordance with a second embodiment of the present application.

FIG. 12 is another structural diagram of an apparatus of recommending Internet transaction in accordance with a second embodiment of the present application.

FIG. 13 is a structural diagram of the example apparatus as described in FIGS. 11 and 12 in more detail.

### DETAILED DESCRIPTION

In order to provide an implementing solution of reducing the occupancy of network resources due to the blind selection of information objects by users, the embodiments of the present disclosure provide a method and an apparatus of recommending an Internet transaction. This technical solution can be applied in a process of implementing an Internet transaction, e.g., a process of searching an information object by a user, or a process of reviewing evaluation information of the information object by the user, and a process of reviewing information objects by the user through client software. The exemplary embodiments of the present disclosure will be described in further detail below in conjunction with the accompanying figures. It should be noted that the exemplary embodiments are merely used for describing and explaining the present disclosure, and are not intended to be construed as limitations of the present disclosure. The embodiments and features of the embodiments of the present disclosure can be combined with one another where no conflict exists there between.

### First Embodiment

The method of recommending an Internet transaction provided by the first embodiment of the present application may create user groups for users in advance. A user group of each user includes at least two users. When a user conducts an Internet transaction request, optimization may be performed for a feedback result of the transaction request based on Internet transaction activity information of other users within a user group of the user.

An Internet transaction request involved in the embodiments of the present disclosure may include a transaction request for various functions provided in the Internet. For example, with respect to a search function provided in the Internet, the Internet transaction request may be a search request for an information object. The search request may include key information of an information object requested to be searched for, e.g., descriptive information that characterizes the information object such as a keyword and/or a geographical location. With respect to an information access function provided in the Internet, the Internet transaction request may be an access request for an Internet transaction activity associated with an information object designated by a user, e.g., accessing evaluation information for an information object purchased by user(s).

Information objects involved in the embodiments of the present disclosure correspond to various objects that are informatively describable, and may include various types of objects involving Internet service, for example, client objects and web page objects. More particularly, these information objects may be objects, such as product information, electronic information, etc., that may be presented on terminal devices.

Internet transaction activity information involved in the embodiments of the present disclosure may include various types of activity information generated with a user playing a primary role, such as an activity associated with purchasing an information object by the user, an activity associated with evaluating the information object by the user, etc.

A feedback result of an Internet transaction request involved in the embodiments of the present disclosure is a result determined by a web server to be sent to a client device of the Internet transaction request based on the corresponding Internet transaction request. For example, when the Internet transaction request is a search request, a corresponding feedback result is a search result that is determined to match keyword information based on the search key information included in the search request. When the Internet transaction request is the aforementioned access request, a corresponding feedback result is a list of Internet transaction activities that are requested to be accessed and match the access request. The list includes Internet transaction activity information of users corresponding to the information object. For example, the list may include purchase records of all users who have purchased the information object, or evaluation records of all the users who have purchased the information object. In a real application, these two types of records may be included at the same time.

A user group involved in the embodiments of the present disclosure corresponds to a group having multiple users, and in a real application scenario, may be called a collection of users such as friend circles, user circles, etc.

A friend relationship involved in the embodiments of the present disclosure may be a unidirectional friend relationship or a bidirectional friend relationship. For example, a first user adds a second user as a friend, and the second user is included in a friend list of the first user. The first user may be included in a friend list of the second user (this type of situation corresponds to a bidirectional friend relationship), or may not be included in the friend list of the second user (this type of situation corresponds to a unidirectional friend relationship). Particularly, a user or a server may set up a unidirectional or bidirectional friend relationship. Similarly, a request for adding a user in the embodiments of the present disclosure may be to add the user unidirectionally, i.e., adding the user requested to be added to a user group of a requesting party only, or may be to add the user bi-directionally, i.e., adding the user requested to be added and the requesting party mutually to respective user groups of opposite parties.

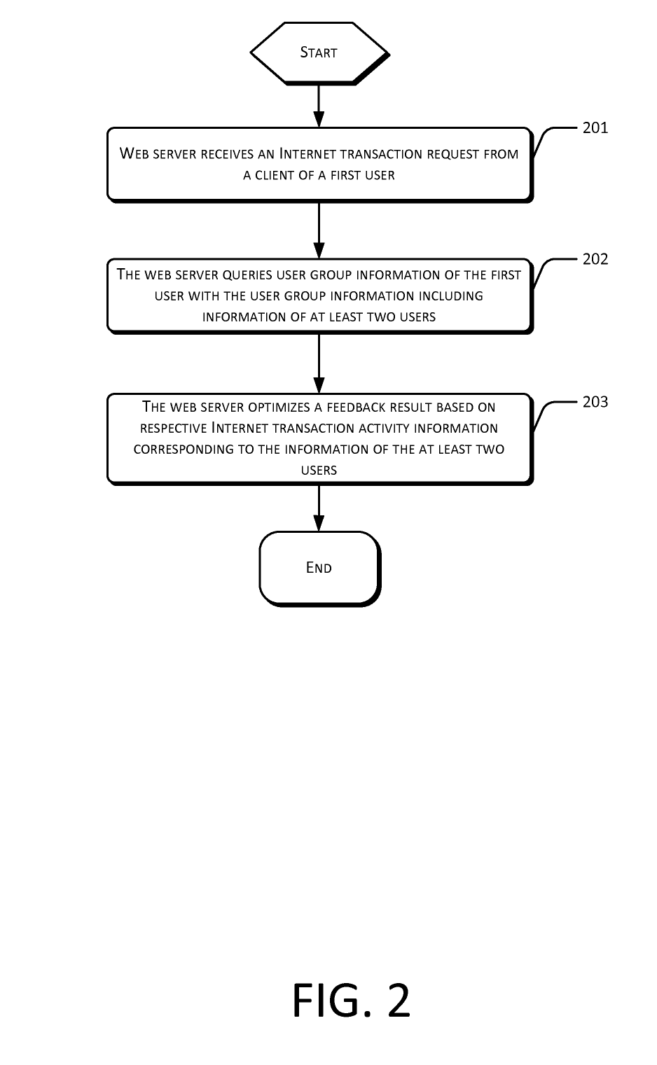

The technical scheme provided in the embodiments of the present disclosure may be used in a system involving interaction between a web server and a client. Specifically, FIG. 2 shows a process of recommending an Internet transaction in accordance with the first embodiment. This process includes the following blocks 201 to 203.

At block 201, a web server receives an Internet transaction request sent from a client of a first user.

At block 202, the web server queries information of a user group associated with the first user. The information of the user group includes information of at least two users.

At block 203, the web server performs optimization for a feedback result of the Internet transaction request based on respective Internet transaction activity information corresponding to the information of the at least two users.

The process of recommending an Internet transaction is finished at this point.

Using the process in FIG. 2, after receiving an Internet transaction request sent from a client of a user, a web server determines a feedback result of the Internet transaction request on the one hand, and queries information of a user group of the user on the other hand. Based on Internet transaction activity information of other users in the user group information, the web server performs optimization for the feedback result of the Internet transaction request. Compared with existing technologies, the technical scheme of the present disclosure can optimize a feedback result based on Internet transaction activities of other users prior to returning the feedback result associated with an Internet transaction. Compared to the blind selection method of entering into an information object to review user evaluation by a user in the existing technologies, a feedback result which is returned to the user has undergone optimization based on Internet activity information of users (e.g., evaluation information of the users for information objects) using the technical scheme of the present disclosure, thus achieving a goal of helping the user to select an information object, improving the efficiency of selecting an information object that meets a demand of the user, reducing the occupancy of network resources and improving the service efficiency of a web server.

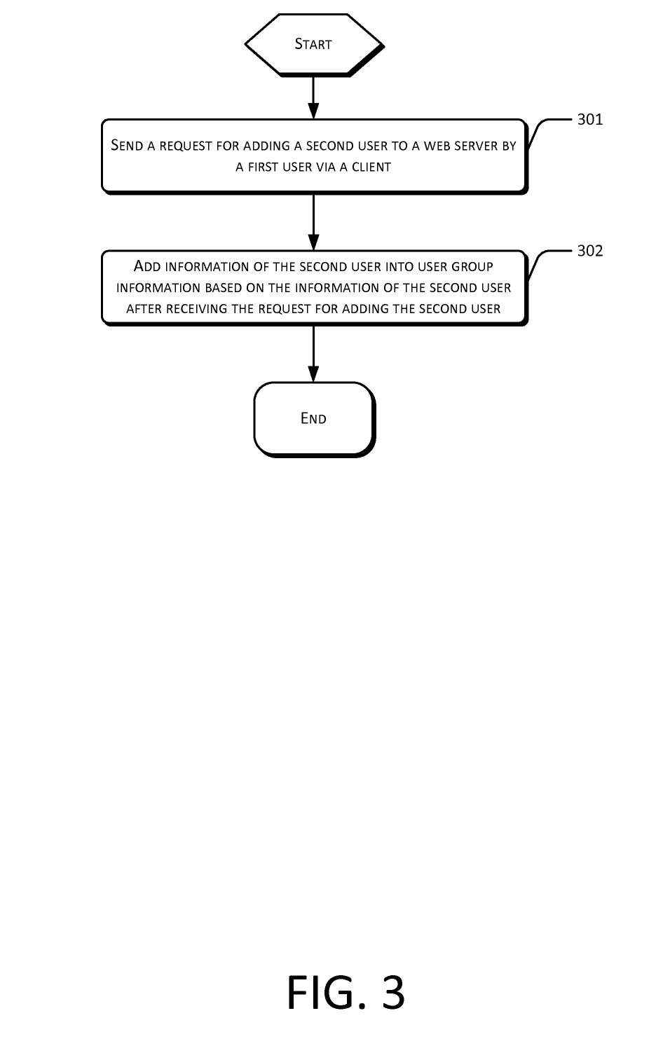

As described in the foregoing, in the technical scheme provided by the embodiments of the present disclosure, a user group is created for a user in advance, i.e., creating a user group for a first user before receiving an Internet transaction request that is sent from a client of the first user. Specifically, FIG. 3 shows a flowchart illustrating a process of creating a user group for a first user, which may include the following blocks:

At block 301, a first user sends a request for adding a second user to a web server through a client.

In this block, a user may select a user to be added in many different ways, such as by selecting a user who is located nearby geographically, selecting a user in an address book, selecting a social friend in a social network, or randomly searching for a user. The social network may include a variety of types such as Micro Blog, WeChat, MSN, etc., and will not be individually described herein. The user may set up various configurations in advance, e.g., whether to allow an addition of a friend through an address book, whether to allow an addition of a friend through nearby users, and will not be individually described herein.

At block 302, after receiving the request for adding the second user, the web server adds information of the second user to information of a user group of the first user based on the information of the second user included in the request.

In this block, if the user group of the first user has already existed, the information of the second user is directly added to the user group. If the user group of the first user does not exist, a user group is created for the first user, and the second user is added.

The process of creating a user group of a first user is finished at this point.

According to the process in FIG. 3, the first user may add more users into the user group.

Furthermore, in the exemplary embodiment of creating a user group provided in the present disclosure, in order to facilitate a user to add user(s) into a user group, the user(s) who may be added is/are further recommended after receiving a request for adding a second user into a user group sent from a client of a first user. Specifically, the server may recommend associated friends of the second user to the client of the first user, or may automatically add the associated friends of the second user into the information of the user group of the first user. The associated friends of the second user correspond to friends who are within information of a user group of the second user and satisfy a class scope predefined by the first user. More specifically, associated friends of the second user are determined based on a friend relationship to confirm associated users of the second user. It should be understood that the method of recommending associated friends of a second user to a client of a first user by the server is merely an example method. In a real application, the server may directly add information of the associated friends of the second user to the information of the user group of the first user. In a real application, which method is to be applied may be configured by a user.

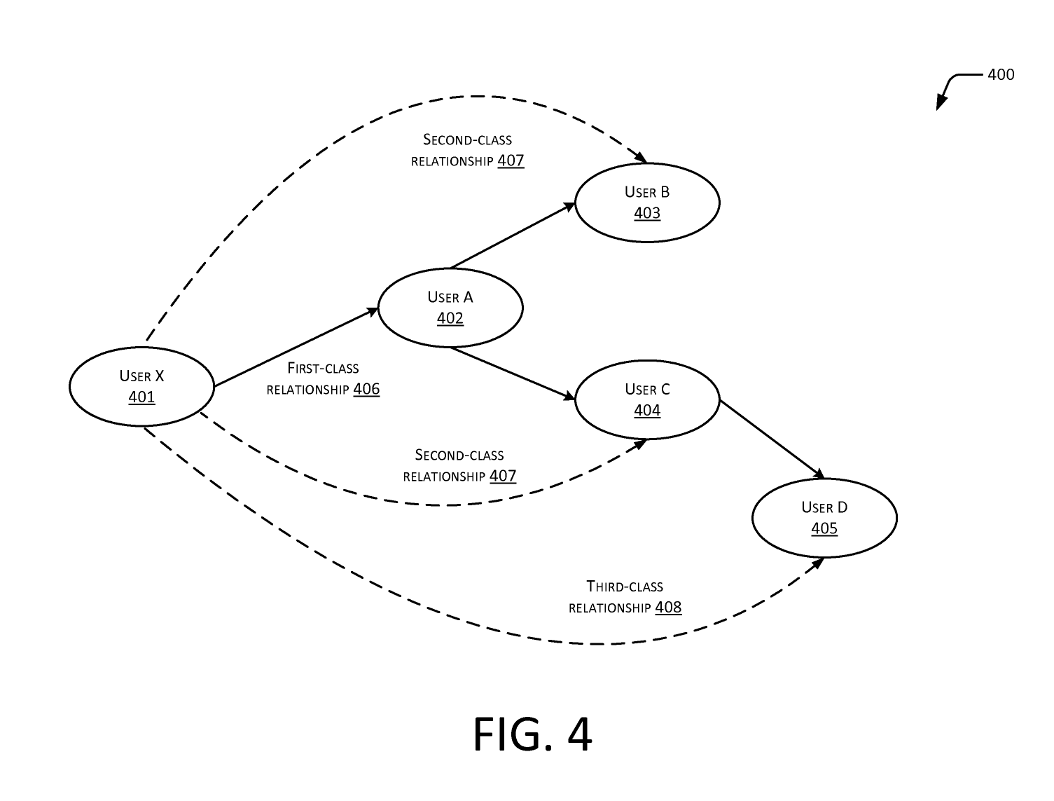

In order to better understand the technical solution of the present disclosure, an example process of adding associated friends is illustrated in combination with FIG. 4. FIG. 4 shows a schematic diagram of user relationships 400. A collection of five users, namely, user X 401, user A 402, user B 403, user C 404 and user D 405 is called a user group of user X (or called a friend circle of user X). User X and user A have a friend relationship. User A, user B and user C have a friend relationship. User C and user D have a friend relationship. If a pre-defined class is two levels, the web server recommends two classes of friends of user A to user X after user X sends a request for adding user A as a friend to the server, i.e., user B (a first-class friend of user A), user C (a first-class friend of user A) and user D (a second-class friend of user A). Accordingly, user X may add multiple friends through a single operation of friend addition under recommendation of the web server, thus leading to a user group having multiple classes of friend relationship, where user X and user A have a first-class friend relationship 406, user X, user B and user C have a second-class friend relationship 407, and user X and user D have a third-class friend relationship 408. Moreover, a friend relationship may be shown directly as a friend of first class, a friend of second class or a friend of third class in the user group of user X as shown in FIG. 4. Furthermore, user X may adjust a class at which an added user is located, such as adjusting user C as a friend of first class, user D as a friend of second class, and user B as a friend of third class, for example. Apparently, in a real application scenario, first-class friends, second-class friends and third-class friends may be deprived of classification, and displayed as friends of user X.

A relationship of a user group shown in FIG. 4 is merely an example embodiment of the present disclosure. The technical scheme provided in the embodiments of the present disclosure can support a user to flexibly configure whether to desire a server to recommend associated friends of a user who is requested to be added, configure a desired depth of classes of friends recommended by the server, and/or configure a desired method used by the server for recommending friends. For example, as shown in FIG. 4, a recommendation may be made using users as units or recommendation may be made using groups as units, such as groups of gender, age, geographical location, etc., as units for making recommendation. A specific recommendation method can be flexibly configured, and will not be individually described herein.

After creating the user group, the web server may perform optimization for the feedback result of the transaction request based on the Internet transaction activities of users in the user group. In order to have a better understanding of the embodiments of the present disclosure, respective optimization processes for different types of Internet transaction requests are described below.

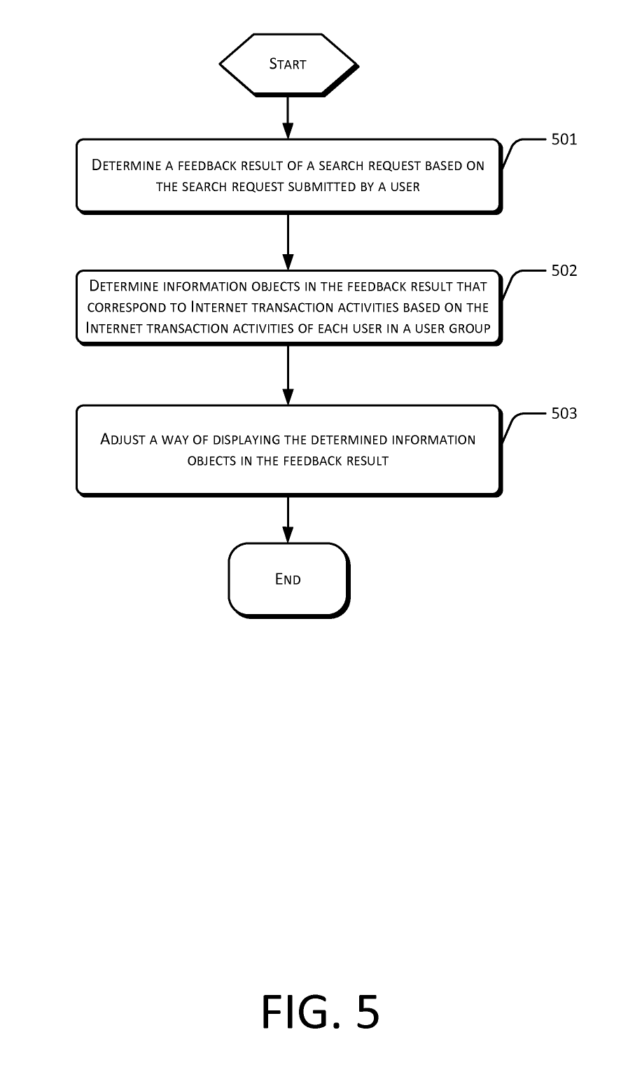

FIG. 5 illustrates a flowchart illustrates an optimization process when an transaction request is a search request for an information object in accordance with the first embodiment of the present disclosure, which may include the following blocks:

Block 501 determines a feedback result of a search request according to the search request submitted by a user.

A handling process of this block is the same as a handling process of an existing search process. Specifically, a search request generally includes a search criterion (for example, descriptive information that characterizes an information object, such as a keyword and/or a geographical location, etc.). Based on the search criterion in the search request, the web server searches for all information objects that comply with the search criterion to form a feedback result (known as a search result).

Block 502 determines, based on Internet transaction activities of each user in a user group of the user, information object(s) that correspond(s) to the Internet transaction activities in the feedback result of the search request.

For the sake of description, the Internet transaction activities of each user included in the user group of the user will be referred as “activities of an associated user” hereinafter. In this block, determining an information object that corresponds to an Internet transaction activity in a feedback result of a search request is to determine an information object for which an Internet transaction activity of an associated user is generated. For example, if user X purchases an information object M, an information object that corresponds to this transaction activity of user X is determined to be M.

Block 503 adjusts a way of displaying the determined information object(s) in the feedback result.

In this block, a display method may be set up in advance. A display order of the determined information object(s) in the feedback result may be adjusted, for example, displayed first, i.e., displayed at first few positions in the feedback result. Alternatively, the determined information object(s) may be highlighted in the feedback result. Alternatively, the determined information object(s) may be displayed independently as separate feedback results. In a real application, one or all of these three types of display methods may be adopted. Which display method is to be adopted may be set up by the user in advance.

The optimization process when an Internet transaction request is a search request for an information object is finished at this point.

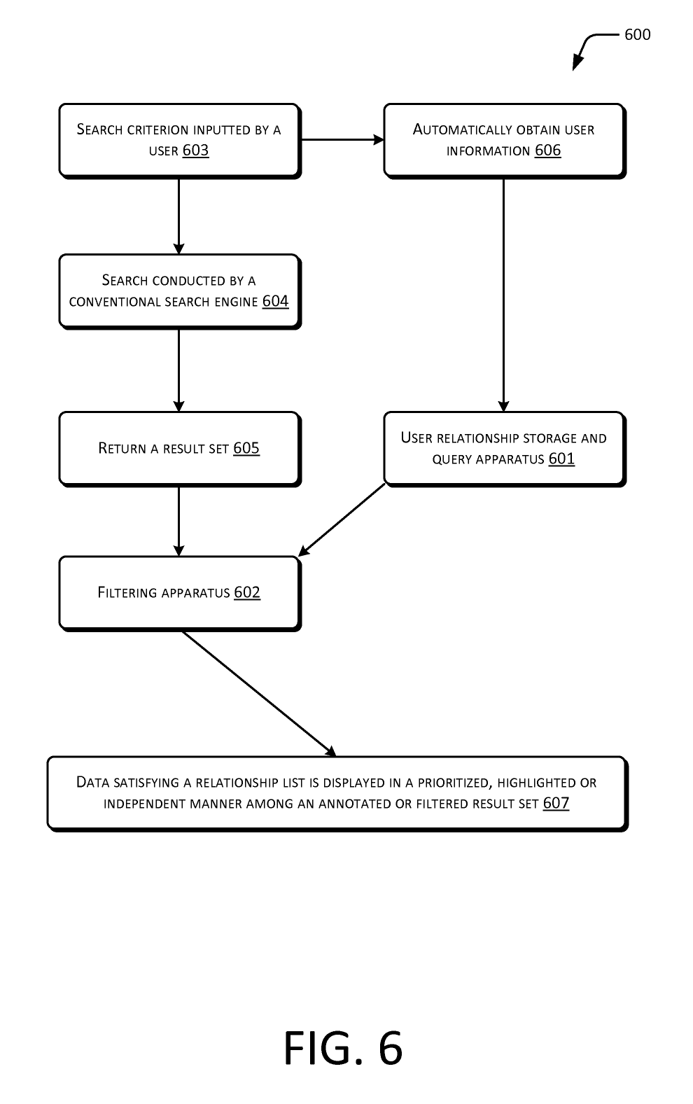

Furthermore, FIG. 6 is a schematic diagram of the optimization process corresponding to FIG. 5 in a real application 600. As shown in FIG. 6, a user relationship storage query apparatus 601 is introduced to store and query information of a user group. A filtering apparatus 602 is introduced to perform optimization processing for a feedback result of a search request. Specifically, on the one hand, after a user inputs a search criterion 603, a conventional search engine is used to conduct a search 604 and return a result set 605 (i.e., a feedback result) to the filtering apparatus 602. On the other hand, after the user inputs the search criterion 603, user information of a corresponding submitted request is automatically obtained 606, and the user relationship storage query apparatus 601 queries user information of the stored user group information based on the obtained user information and submits a query result to the filtering apparatus 602. After receiving the user group information provided by the user relationship storage query apparatus 601, the filtering apparatus 602 performs an optimization processing for the result set returned by the conventional search engine based on associated user activities in the user group to obtain an annotated or filtered result set, with data satisfying a relationship list being displayed in a prioritized, highlighted or independent manner 607. The relationship list refers to friend relationship(s) in the user group of the user, and data of the relationship list refers to Internet transaction activity information of the friend relationship(s).

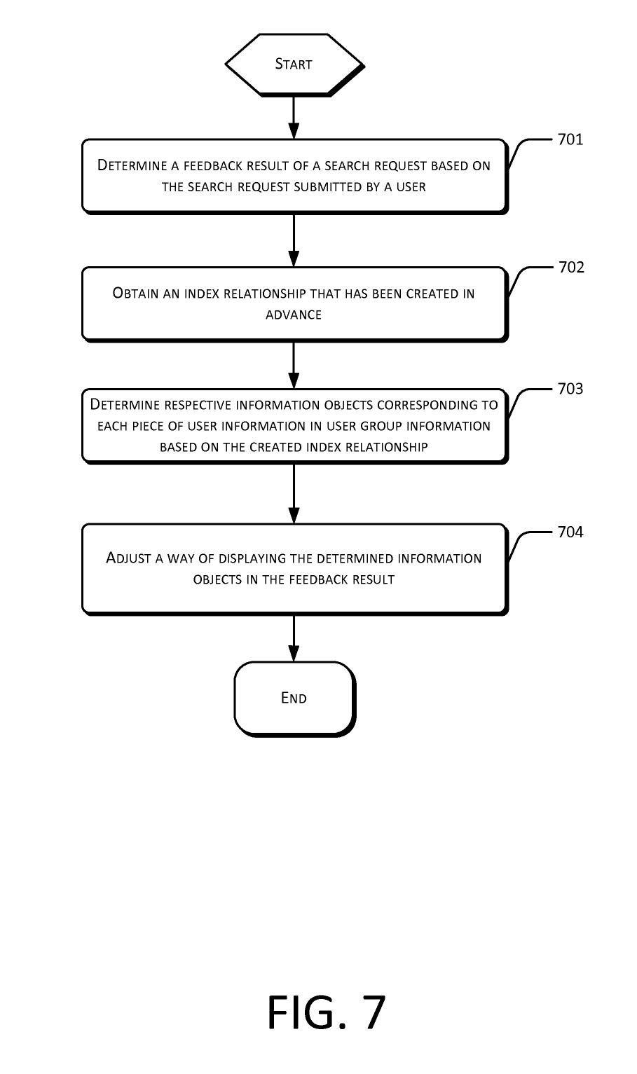

FIG. 7 illustrates another optimization process when an Internet transaction request is a search request for an information object, which may include the following blocks:

Block 701 determines a feedback result of a search request based on the search request submitted by a user.

An implementation principle of this block is the same as that of block 501, and is not redundantly described herein.

Block 702 obtains an index relationship that has been created in advance.

In this block 702, an index relationship may be created prior to perform an optimization processing for a feedback result of an Internet transaction request. Specifically, a process of creating an index relationship includes: for each user having generated an Internet transaction activity, creating an index relationship between information of that user and at least one information object based on the Internet transaction activity of the user, where an information object having an index relationship with a user corresponds to an Internet transaction activity of the user. For example, if an information object is a product, user A has purchased product 1, product 2 and product 3, user B has purchased product 2, product 4 and product 6, user C has purchased product 1, product 3 and product 5, an index relationship that is created may be as follows:

“user A—product 1-product 2-product 3”

“user B—product 2-product 4-product 6”

“user C—product 1-product 3-product 5”

Block 703 determines information object(s) corresponding respectively to each piece of user information in the user group information of the first user based on the created index relationship.

In this block, an information object that corresponds to user information refers to an information object for which an Internet transaction activity of that user is caused. Based on the above index relationship, if a user group of a certain first user includes user B and user C, determined information objects are product 2, product 4, merchandise 5, product 6 and product 7.

Block 704 adjusts a way of displaying the determined information object(s) in the feedback result.

An implementation principle of block 704 is basically the same as the implementation principle of block 503, and is not redundantly described herein.

The optimization process when an Internet transaction request is a search request for an information object is finished at this point.

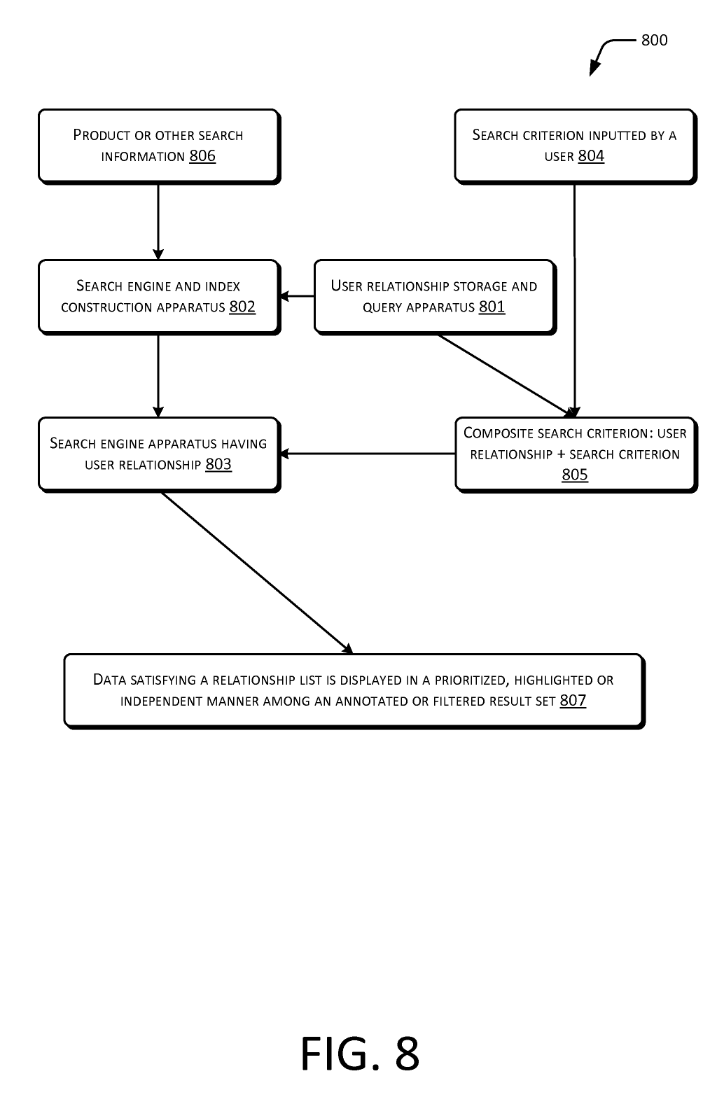

Furthermore, FIG. 8 shows a schematic diagram of the optimization process corresponding to FIG. 7 in a real application 800. A user relationship storage apparatus 801 is introduced to store and query information of a user group of each user. A search engine and index construction apparatus 802 is introduced to construct an index relationship, and a search engine apparatus 803 that includes user relationship(s) is introduced to perform an optimization processing for a feedback result of a search request. Specifically, after a user inputs a search criterion 804, a composite query criterion 805, i.e., user relationship+search condition, is determined by querying the user relationship storage apparatus 801 on the one hand. The composite query criterion 805 is provided to the search engine apparatus 803 that includes the user relationship(s). On the other hand, the search engine and index construction apparatus 802 employs product or other search information 806 and a user relationship as base data to create an index relationship for use by the search engine apparatus 803 that includes the user relationship(s). The search engine apparatus 803 that includes the user relationship(s) queries for a search result set that satisfies the search criterion inputted by the user based on the index relationship and the composite query criterion 805, and performs an optimization process for the result set based on the index relationship and the user relationship to obtain an annotated or filtered result set, with data satisfying a relationship list is displayed in a prioritized, highlighted or independent manner 807. The optimization processing for the result set that is performed based on the index relationship and the user relationship can be referenced to the process of the above blocks 703 to 704.

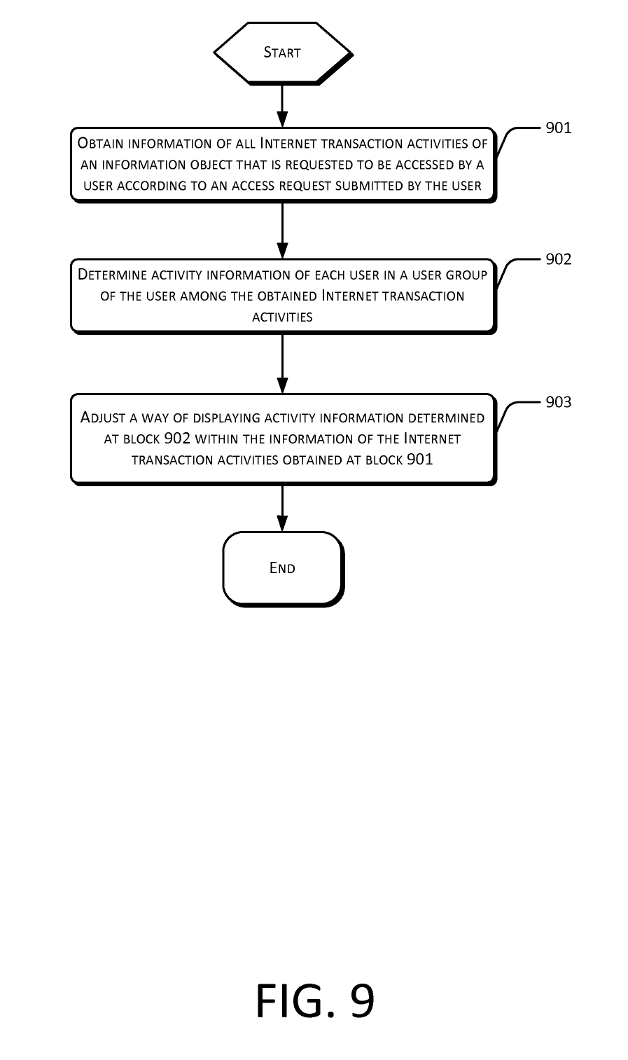

FIG. 9 shows an optimization process when an Internet transaction request is an access request, and includes the following blocks:

Block 901 obtains information of Internet transaction activities associated with an information object requested to be accessed by a user based on an access request submitted by the user.

Block 902 determines activity information of each user in a user group of the user from the obtained Internet transaction activities.

Block 903 adjusts a way of displaying an activity determined at block 902 in the information of Internet transaction activities obtained at block 902.

Similar to above block 503, the adjustment of the way of displaying the Internet transaction activity information determined at block 902 in the Internet transaction activity information determined at block 901 may be set up in advance. For example, a display order may be adjusted, a highlighted display may be adjusted, or a separate display of the determined Internet transaction activity information may be adjusted. In a real application, one or all of these three display methods may be applied.

The optimization process when an Internet transaction request is an access request for an information object is finished at this point.

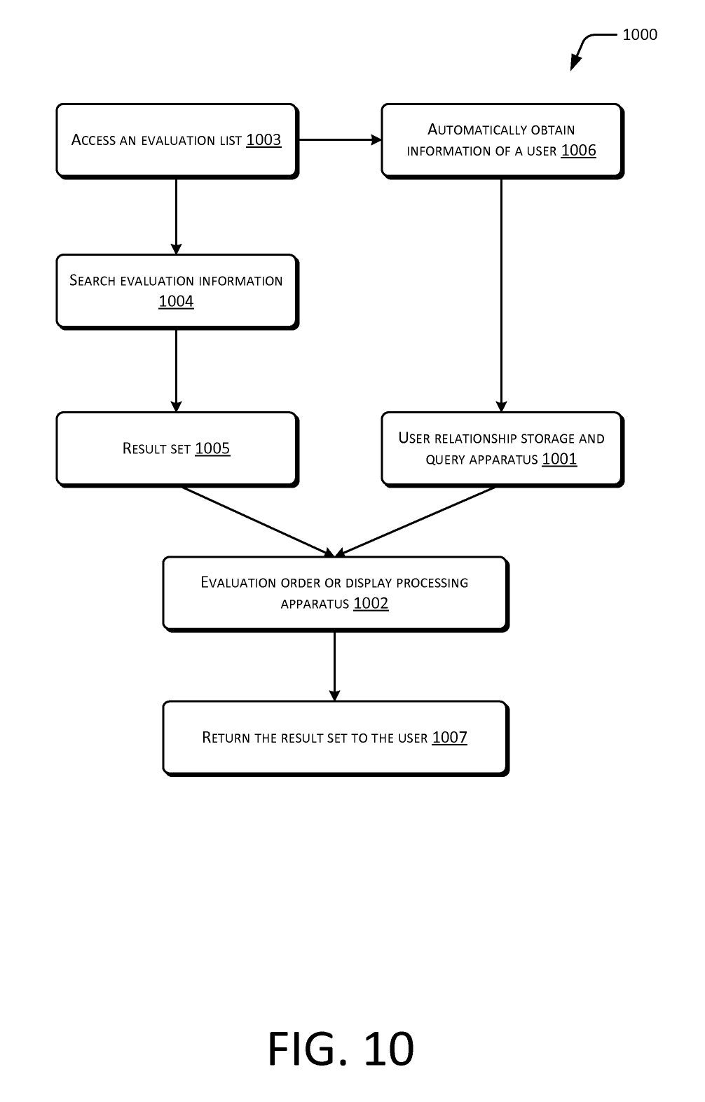

Furthermore, FIG. 10 shows a schematic diagram of the optimization process corresponding to FIG. 9 in a real application 1000, with an Internet transaction activity requested for access by a user being taken as evaluation information of an information object given by user(s) who has/have purchased the information object for illustration. As shown in FIG. 10, a user relationship storage apparatus 1001 is introduced to store and query information of a user group. An evaluation order or display processing apparatus 1002 is introduced to perform an optimization processing for a result set. Specifically, after a user requests to access an evaluation list 1003 at a display interface of an information object, evaluation information is searched 1004 to obtain a result set 1005 on the one hand, and user information of the user who submits the access request is obtained automatically 1006 and provided to the user relationship storage query apparatus 1001 for determining information of a user group of the user on the other had. Furthermore, a determined result is provided from the user relationship storage query apparatus 1001 to the evaluation order or display processing apparatus 1002. The evaluation order or display processing apparatus 1002 queries evaluation information of corresponding user(s) in a result set based on the obtained information of the user group, presents the evaluation information of the corresponding user(s) using a prioritized, independent or highlighted manner of display, and returns the final result set to the user 1007.

The above technical schemes provided by the embodiments of the present disclosure include the following beneficial effects:

With the help of N number of classes of friend relationship, a user may rapidly establish a large number of friend relationships using a friend group (or a friend circle). Due to the particularity needed in evaluation associated with purchases, a lot of personal information (such as ID) associated with members in the circle does not need to be disclosed, but only records of evaluation associated with purchases and recommendation information of friends in the circle as a whole need to be presented. Minor adjustment may further be made to internal relationships thereof, for example, expelling those users who give malicious evaluation or send out advertisements from the circle.

Purchase groups are aggregated by way of establishing user groups. Aggregated group indicators (i.e., user groups) are introduced in a subsequent process of displaying evaluation information. Evaluation of a same group of a buyer or original product information is displayed first to directly guide the buyer to make a purchase based on evaluation information that he/she originally trusts.

By treating buyers in a friend group as an entry, purchase activities thereof are induced in the friend group to achieve the goal of repeated purchases within the group.

By aggregating buyers through establishing user groups, the influence of negative evaluations in an aggregated group (i.e., a friend group) is suitably increased, thus separating a global evaluation relationship between a buyer and a seller, achieving a high efficient circulation of negative evaluation information given by the buyer within the group, and avoiding a direct conflict between the buyer and the seller. On the other hand, a malicious evaluation activity that greatly affects an online store is eliminated from negative evaluation in the group of aggregated buyers.

A bypass setting is provided to a buyer by establishing a user group, dividing original large and complete search, transaction and evaluation into smaller sized transaction groups. By establishing an associated relationship between a seller and a user group, the seller can focus on serving the user group that is relatively stable, thus avoiding the occurrence of a strong Matthew effect. At the same time, the purchase experience of both seller and buyer is improved, and the efficiency of performing differentiated services by the seller through fixed user groups may be improved.

### Second Embodiment

Corresponding to the method of recommending Internet transaction provided by the above first embodiment, a second embodiment of the present disclosure provides an apparatus of recommending Internet transaction. This apparatus may be located in a server of a network side.

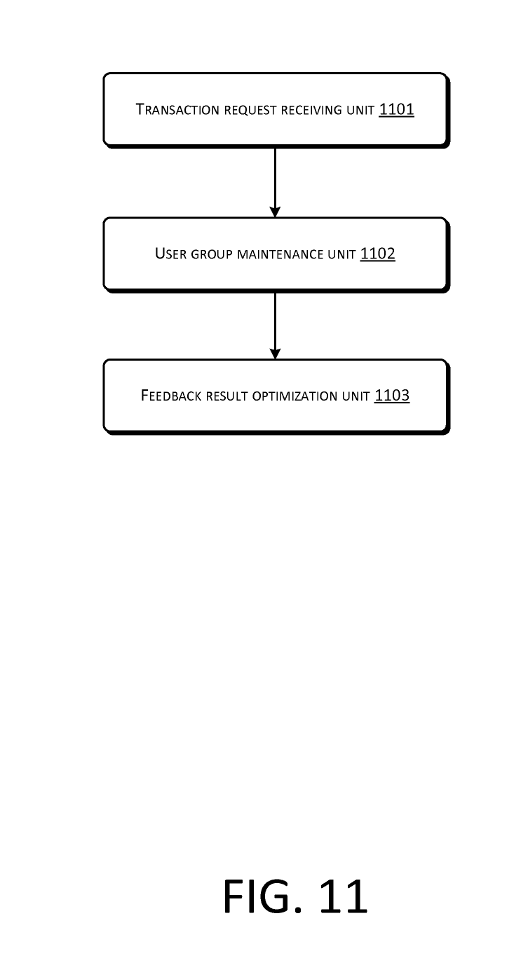

FIG. 11 shows a structural diagram of an apparatus of recommending an Internet transaction provided in the present embodiment. Specifically, the apparatus includes a transaction request receiving unit 1101, a user group maintenance unit 1102, and a feedback result optimization unit 1103.

The transaction request receiving unit 1101 is used for receiving an Internet transaction request from a client of a first user.

The user group maintenance unit 1102 is used for querying user group information of the first user, the user group information including information of at least two users.

The feedback result optimization unit 1103 is used for optimizing a feedback result of the Internet transaction request based on Internet transaction activity information corresponding to the information of the at least two users.

In an exemplary embodiment of the present disclosure, the user group maintenance unit 1102 included in the apparatus of FIG. 11 is further used for receiving a request for adding a second user to a user group from the client of the first user, and adding information of the second user to the user group information of the first user based on the information of the second user included in the request for adding the second user.

In an exemplary embodiment of the present disclosure, the user group maintenance unit 1102 included in the apparatus of FIG. 11 is further used for recommending an associated friend of the second user to the client of the first user or automatically adding the associated friends of the second user to the user group information of the first user after receiving the request for adding the second user to the user group from the client of the first user, where the associated friend of the second user corresponds to a friend satisfying a class scope predefined by the first user in user group information of the second user.

In an exemplary embodiment of the present disclosure, the transaction request receiving unit 1101 included in the apparatus of FIG. 11 is further used for receiving a search request for an information object from the client of the first user or an access request for accessing Internet transaction activities generated for an information object that is designated by the user.

In an exemplary embodiment of the present application, the feedback result optimization unit 1103 included in the apparatus of FIG. 11 is used for:

when the Internet transaction request includes an search request for an information object, determining information object(s) corresponding to Internet transaction activities in the feedback result of the search request based on respective Internet transaction activities corresponding to the information of the at least two users, and adjusting a way of displaying the determined information object(s) in the feedback result; or

when the Internet transaction request includes an access request, determining the respective Internet transaction activities corresponding to the information of the at least two users among Internet transaction activities of all users that correspond to the designated information object, and adjusting a way of displaying the determined Internet transaction activities in the Internet transaction activities of all the users.

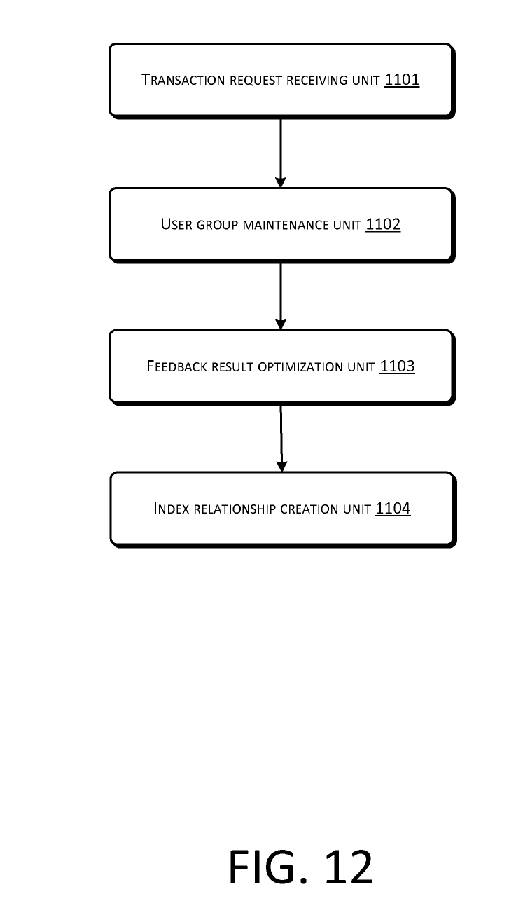

As shown in FIG. 12, in an exemplary embodiment of the present disclosure, the apparatus of FIG. 11 may further include:

an index creation unit 1104 used for, for each user conducting an Internet transaction activity, establishing an index relationship between information of the user and at least one information object according to the Internet transaction activity of the user, where the information object having the index relationship with the user corresponds to the Internet transaction activity of the user.

Correspondingly, the feedback result optimization unit 1103 is used for determining respective information objects corresponding to each piece of user information in the user group information of the first user based on the index relationship created by the index creation unit, and adjusting the way of displaying the determined information object(s) in the feedback result.

Functions of the above units or modules may correspond to the specific processing of corresponding processes in the above first embodiment, and will not be redundantly described herein.

The apparatus of recommending an Internet transaction provided by the embodiments of the present disclosure may be implemented using a computer program. One skilled in the art should understand that the above method of dividing units and modules is merely one of a number of types of division methods. Whether other units or modules are divided or no division is made should also be included in the protection scope of the present disclosure as long as a recommendation apparatus of an information object possesses the above functions.

One skilled in the art should understand that the embodiments of the present disclosure may be implemented as methods, apparatuses (devices), or products of computer programs. Therefore, the present disclosure may be implemented in forms of hardware, software, or a combination of hardware and software. Further, the present disclosure may be implemented in the form of products of computer programs executable on one or more computer readable storage media (including, but not limited to, a disk storage device, a CD-ROM, an optical storage device, etc.) that include computer readable program instructions.

The present disclosure is described in accordance with flowcharts and/or block diagrams of the exemplary methods, apparatuses (devices) and computer program products. It should be understood that each process and/or block and combinations of the processes and/or blocks of the flowcharts and/or the block diagrams may be implemented in the form of computer program instructions. Such computer program instructions may be provided to a general purpose computer, a special purpose computer, an embedded processor or another processing apparatus having a programmable data processing device to generate a machine, so that an apparatus having the functions indicated in one or more blocks described in one or more processes of the flowcharts and/or one or more blocks of the block diagrams may be implemented by executing the instructions by the computer or the other processing apparatus having programmable data processing device.

Such computer program instructions may also be stored in a computer readable memory device which may cause a computer or another programmable data processing apparatus to function in a specific manner, so that a manufacture including an instruction apparatus may be built based on the instructions stored in the computer readable memory device. That instruction device implements functions indicated by one or more processes of the flowcharts and/or one or more blocks of the block diagrams.

The computer program instructions may also be loaded into a computer or another programmable data processing apparatus, so that a series of operations may be executed by the computer or the other data processing apparatus to generate computer implemented processing. Therefore, the instructions executed by the computer or the other programmable apparatus may be used to implement one or more processes of the flowcharts and/or one or more blocks of the block diagrams.

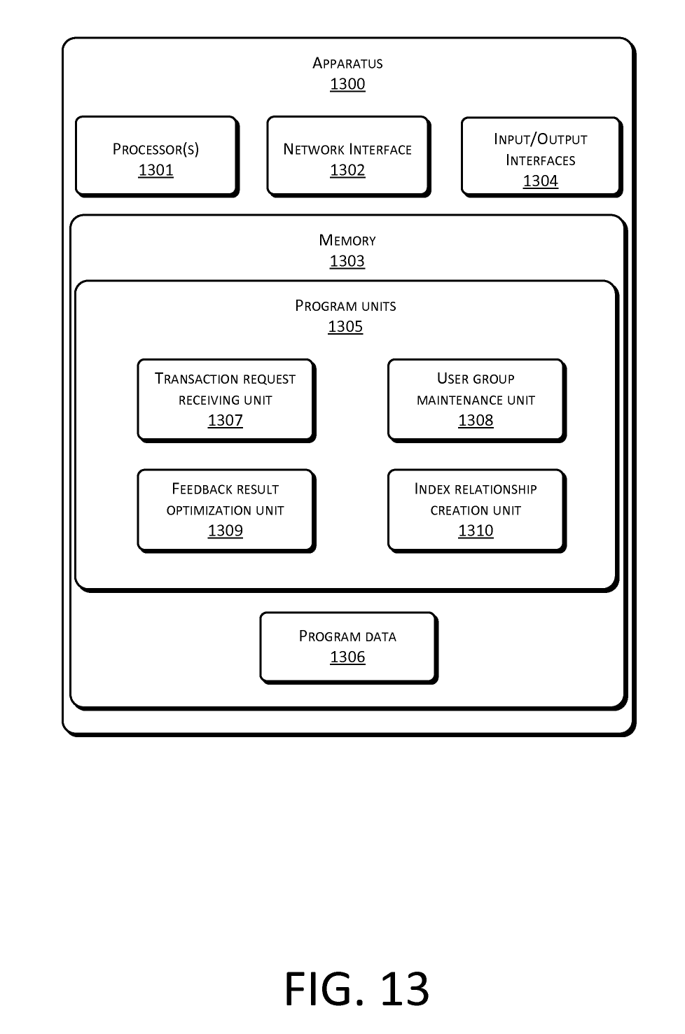

FIG. 13 illustrates an example apparatus 1300, such as the apparatuses as described above, in more detail. In one embodiment, the client device 1300 can include, but is not limited to, one or more processors 1301, a network interface 1302, memory 1303, and an input/output interface 1304.

The memory 1303 may include computer-readable media in the form of volatile memory, such as random-access memory (RAM) and/or non-volatile memory, such as read only memory (ROM) or flash RAM. The memory 1303 is an example of computer-readable media.

Computer-readable media includes volatile and non-volatile, removable and non-removable media implemented in any method or technology for storage of information such as computer readable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 1303 may include program units 1305 and program data 1306. In one embodiment, the program units 1305 may include a transaction request receiving unit 1307, a user group maintenance unit 1308, a feedback result optimization unit 1309 and an index relationship creation unit 1310. Details about these program units may be found in the foregoing embodiments described above.

Although exemplary embodiments of the present disclosure are described, one skilled in the art may change and modify theses exemplary embodiments upon understanding the underlying inventive concepts thereof. Therefore, claims attached herein are intended to cover the exemplary embodiments and all the changes and modifications that fall into the scope of the present disclosure. Apparently, one skilled in the art may make changes and modifications of the present disclosure without departing from the spirit and scope of the present disclosure. If these changes and modifications are within the scope of the claims and their equivalents of the present disclosure, the present disclosure intends to covers such changes and modifications.

What is claimed is:

1. An method of recommending an Internet transaction, comprising:
receiving an Internet transaction request from a client of a first user;
querying information of a user group of the first user, the information of the user group comprising information of at least two users; and
performing optimization for a feedback result of the Internet transaction request based on respective Internet transaction activity information corresponding to the information of the at least two users.

2. The method as recited in claim 1, wherein, prior to receiving the Internet transaction request from the client of the first user, the method further comprises:
receiving a request for adding a second user to the user group from the client of the first user; and
adding information of the second user to the information of the user group of the first user based on the information of the second user included in the request for adding the second user.

3. The method as recited in claim 2, wherein:
the second user is located geographically close to the first user;
the second user is a user in an address book of the first user;
the second user is a social friend of the first user; and/or
the second user is a user found randomly by the first user.

4. The method as recited in claim 2, wherein, after receiving the request for adding the second user to the user group from the client of the first user, the method further comprises:
recommending an associated friend of the second user to the client of the first user; or
automatically adding the associated friend of the second user to the information of the user group of the first user, wherein the associated friend of the second user is a friend satisfying a class scope predefined by the first user in user group information of the second user.

5. The method as recited in claim 1, wherein the Internet transaction activity information comprises activity information of an information object purchased by users and/or activity information of an information object evaluated by the users.

6. The method as recited in claim 1, wherein the Internet transaction request comprises:
a search request for an information object; or
an access request for accessing Internet transaction activities generated for an information object designated by the user.

7. The method as recited in claim 6, wherein, when the Internet transaction request comprises the search request for the information object, performing the optimization for the feedback result of the Internet transaction request comprises:
determining an information object corresponding to Internet transaction activity information in the feedback result of the search request based on the respective Internet transaction activity information corresponding to the information of the at least two users; and
adjusting a way of displaying the determined information object in the feedback result.

8. The method as recited in claim 6, wherein, when the Internet transaction request comprises the search request for the information object and before performing the optimization for the feedback result of the Internet transaction request, the method further comprises:
for each user having conducted an Internet transaction activity, creating an index relationship between information of a respective user and at least one information object based on information of the Internet transaction activity of the respective user, wherein the information object having the index relationship with the respective user corresponds to the Internet transaction activity of the respective user; and
performing the optimization for the feedback result of the Internet transaction request comprises:
determining a respective information object corresponding to each piece of user information in the information of the user group of the first user based on the index relationship; and
adjusting a way of displaying the determined information object in the feedback result.

9. The method as recited in claim 7, wherein adjusting the way of displaying the determined information object in the feedback result comprises:
adjusting a display order of the determined information object in the feedback result;
adjusting the determined information object in the feedback result to be displayed in a highlighted manner; and/or
adjusting the determined information object in the feedback result to be displayed separately.

10. The method as recited claim 5, wherein, when the Internet transaction request comprises an access request, performing the optimization for the feedback result of the Internet transaction request based on the respective Internet transaction activity information corresponding to the information of the at least two users, comprises:
determining the respective Internet transaction activity information corresponding to the information of the at least two users from Internet transaction activity information of all users that corresponds to a designated information object; and
adjusting a way of displaying the determined Internet transaction activity information in the Internet transaction activity information of all the users.

11. The method as recited in claim 10, wherein adjusting a way of displaying the determined Internet transaction activity information in the Internet transaction activity information of all the users comprises:
adjusting a display order of the determined Internet transaction activity information in the Internet transaction activity information of all the users;
adjusting the determined Internet transaction activity information in the Internet transaction activity information of all the users to be displayed in a highlighted manner; and/or
adjusting the determined Internet transaction activity information in the Internet transaction activity information of all the users to be displayed separately.

12. An apparatus of recommending Internet transaction, comprising:
a transaction request receiving unit used for receiving an Internet transaction request from a client of a first user;
a user group maintenance unit used for querying user group information of the first user, the user group information including information of at least two users; and
a feedback result optimization unit used for optimizing a feedback result of the Internet transaction request based on Internet transaction activity information corresponding to the information of the at least two users.

13. The apparatus as recited in claim 12, wherein the user group maintenance unit is further used for receiving a request for adding a second user to a user group from the client of the first user, and adding information of the second user to the user group information of the first user based on the information of the second user included in the request for adding the second user.

14. The apparatus as recited in claim 13, wherein the user group maintenance unit is further used for recommending an associated friend of the second user to the client of the first user or automatically adding the associated friends of the second user to the user group information of the first user after receiving the request for adding the second user to the user group from the client of the first user, wherein the associated friend of the second user corresponds to a friend satisfying a class scope predefined by the first user in user group information of the second user.

15. The apparatus as recited in claim 12, wherein the transaction request receiving unit is further used for receiving a search request for an information object from the client of the first user or an access request for accessing Internet transaction activities generated for an information object that is designated by the user.

16. The apparatus as recited in claim 15, wherein the feedback result optimization unit is used for:
when the Internet transaction request includes an search request for an information object, determining information object(s) corresponding to Internet transaction activities in the feedback result of the search request based on respective Internet transaction activities corresponding to the information of the at least two users, and adjusting a way of displaying the determined information object(s) in the feedback result; or
when the Internet transaction request includes an access request, determining the respective Internet transaction activities corresponding to the information of the at least two users among Internet transaction activities of all users that correspond to the designated information object, and adjusting a way of displaying the determined Internet transaction activities in the Internet transaction activities of all the users.

17. The apparatus as recited in claim 15, further comprising:
an index creation unit used for, for each user conducting an Internet transaction activity, establishing an index relationship between information of the user and at least one information object according to the Internet transaction activity of the user, where the information object having the index relationship with the user corresponds to the Internet transaction activity of the user, wherein
the feedback result optimization unit is used for determining respective information objects corresponding to each piece of user information in the user group information of the first user based on the index relationship created by the index creation unit, and adjusting the way of displaying the determined information object(s) in the feedback result.

18. One or more computer-readable media storing executable instructions that, when executed by one or more processors, cause the one or more processors to perform acts comprising:
receiving an Internet transaction request from a client of a first user;
querying information of a user group of the first user, the information of the user group comprising information of at least two users; and
performing optimization for a feedback result of the Internet transaction request based on respective Internet transaction activity information corresponding to the information of the at least two users.

19. The one or more computer-readable media as recited in claim 18, wherein, prior to receiving the Internet transaction request from the client of the first user, the acts further comprise:
receiving a request for adding a second user to the user group from the client of the first user; and
adding information of the second user to the information of the user group of the first user based on the information of the second user included in the request for adding the second user.

20. The one or more computer-readable media as recited in claim 19, wherein, after receiving the request for adding the second user to the user group from the client of the first user, the acts further comprise:
recommending an associated friend of the second user to the client of the first user; or
automatically adding the associated friend of the second user to the information of the user group of the first user, wherein the associated friend of the second user is a friend satisfying a class scope predefined by the first user in user group information of the second user.
